(19) United States
(12) Patent Application Publication
(10) Pub. No.: US 2025/0069132 A1
(43) Pub. Date: Feb. 27, 2025

(54) CORRELATING CONSUMER ITEMS AND COMMERCIAL VENDORS

(71) Applicant: INTERNATIONAL BUSINESS MACHINES CORPORATION, ARMONK, NY (US)

(72) Inventors: Michael Baryla, Cary, NC (US); Melanie Dauber, Oceanside, NY (US); Hamid Majdabadi, OTTAWA (CA); Jeremy R. Fox, Georgetown, TX (US); Mauro Marzorati, Lutz, FL (US)

(21) Appl. No.: 18/455,744

(22) Filed: Aug. 25, 2023

(51) Int. Cl. G06Q 30/0601

(52) U.S. Cl. CPC G06Q 30/0639

(57) ABSTRACT

A computer-implemented method, a computer system and a computer program product correlate consumer items and commercial vendors. The method includes capturing an image of an item and a surrounding area. The method also includes identifying the item in the image and determining a vendor for the item by recognizing the surrounding area in the image and associating the surrounding area with the vendor for the item. In addition, the method includes obtaining fulfillment information for the item from a vendor database. Lastly, the method includes generating a virtual model for the vendor for the item on a device associated with a user, where the virtual model includes the image and the fulfillment information for the item.

### BACKGROUND

Embodiments relate generally to the field of virtual modelling and, particularly, to correlating consumer items and commercial vendors in a virtual model.

In today's commercial environment, it may be common for consumers to purchase items from virtual stores using the Internet for reasons of convenience and pricing. Many consumers wish to experience products in person or test functionality prior to purchase, and therefore the physical store may still have some appeal. However, a common consumer practice, known as “showrooming,” may see the consumer visit the physical store to decide which consumer items to purchase but then perform the actual transaction online, leaving the commercial vendor operating the physical store at a loss because the consumer item may not be correlated to the commercial vendor.

### SUMMARY

An embodiment is directed to a computer-implemented method for correlating consumer items and commercial vendors in a virtual model. The method may include capturing an image of an item and a surrounding area. The method may also include identifying the item in the image and determining a vendor for the item by recognizing the surrounding area in the image and associating the surrounding area with the vendor for the item. In addition, the method may include obtaining fulfillment information for the item from a vendor database. Lastly, the method may include generating a virtual model for the vendor for the item, wherein the virtual model includes the image and the fulfillment information for the item.

In another embodiment, the method may include receiving a request for the item from a user based on the virtual model for the vendor for the item and modifying the request for the item by adding an indication of the vendor. In this embodiment, the method may also include transmitting a modified request for the item to a server.

In a further embodiment, the method may include obtaining location data for the surrounding area from a device and associating the surrounding area with the vendor for the item when the location data matches a vendor location.

In yet another embodiment, the determining the vendor for the item may use a machine learning model that predicts the vendor based on prior transactions and the location data.

In still another embodiment, the method may include displaying the request for the item to the vendor for the item and monitoring interactions of the vendor for the item with the request for the item. In this embodiment, the method may also include updating the request for the item based on the interactions.

In another embodiment, the method may include storing the virtual model for the vendor for the item in the vendor database.

In a further embodiment, the method may include obtaining a profile of the user and modifying the fulfillment information for the item based on the profile of the user.

In addition to a computer-implemented method, additional embodiments are directed to a computer system and a computer program product for correlating consumer items and commercial vendors in a virtual model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that correlates consumer items and commercial vendors in a virtual model according to an embodiment.

### DETAILED DESCRIPTION

In the current technological environment, it may be common for commercial transactions to be conducted via e-commerce, i.e., placing and fulfilling orders via the Internet. At the same time, consumers may wish to try out products prior to purchase and potentially test functionality and features, though actual transactions may be completed online. As a result of these trends, a consumer practice known as “showrooming” has become common, where customers visit physical stores operated by commercial vendors to experience consumer items and then purchase the desired items online from different sellers at lower prices, which results in a loss for the commercial vendor due to the lack of connection, or correlation, between the initial browsing of the item and the final transaction.

At the same time, augmented reality (AR) may offer a real-time view of a physical, real-world environment whose elements are “augmented” by computer-generated sensory input such as sound, video, graphics and positioning data. A display of the surrounding area near a user may be enhanced by augmented data pertinent to the surrounding area using an augmented reality device. An augmented reality application may use images in the surrounding environment from a camera, which may also determine the user's position based on global positioning satellite (GPS) data, triangulation of the device's location, or other positioning methods. The application may then overlay the camera view of the surrounding environment with location-based data such as local shops, restaurants and move theaters as well as the distance to landmarks, cities and the like. In addition, the advent of technologies such as Web-based Augmented Reality (WebAR) may exacerbate the “showrooming” issue mentioned above because such technologies do not require a mobile application to function. Rather, users may access augmented reality (AR) experiences directly from their smartphone using the native camera and mobile web browser. As a result, a user may enter a store and see a desired product such as a book, but instead of purchasing the product on the shelf, the user may order the product from an online retailer, for example an alternate physical book or digital e-book at a lower price. The AR technology may facilitate this process by enabling both the selection of the product from an image or other method and then connect the user to the online retailer.

It may therefore be useful to provide a method or system to correlate consumer items and commercial vendors using a virtual model. Such a method or system may capture an image of a surrounding area that may contain the consumer item, for example the physical store operated by a commercial vendor that may be offering the book in the example above. The method or system may generate a virtual model, such as an augmented reality environment, that may be viewed by a user, where the model may add fulfillment information related to the consumer item that may be obtained from the vendor. Once a user selects a consumer item of interest, the consumer item and the commercial vendor may be correlated to one another, such that a request for the consumer item may be transmitted to the commercial vendor for fulfillment. Such a method or system may prevent instances of consumer showrooming and increase the efficiency and use of e-commerce and virtual modelling software, e.g., augmented reality applications, while ensuring that commercial vendors may operate more smoothly in day-to-day commerce and also that more advanced technologies may be adopted by a larger section of the population.

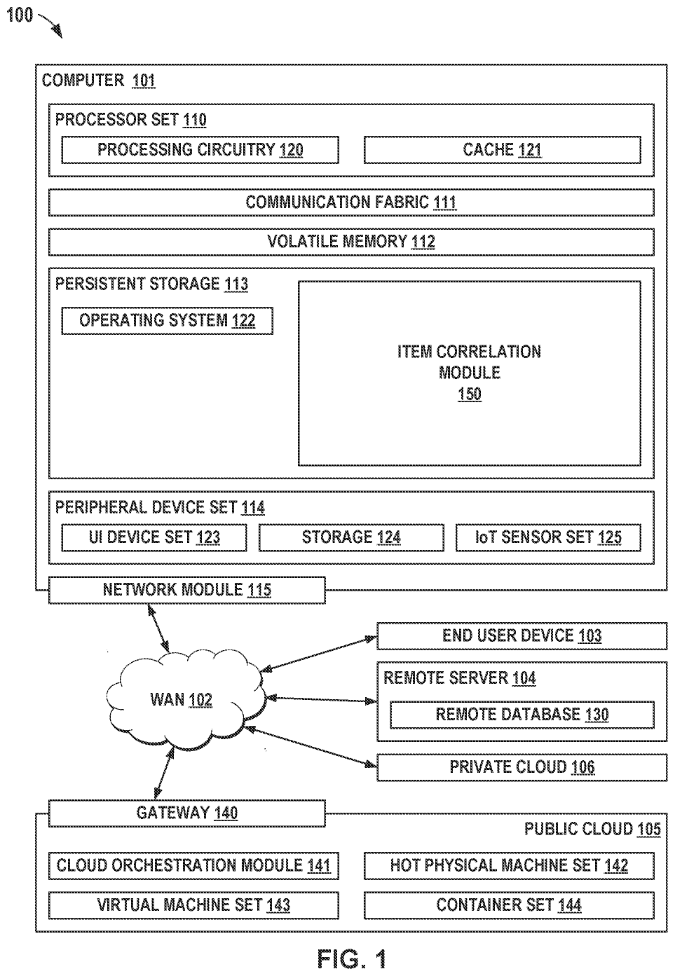

Referring to FIG. 1, computing environment 100 contains an example of an environment for the execution of at least some of the computer code involved in performing the inventive methods, such as item correlation module 150. In addition to item correlation module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and item correlation module 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in item correlation module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in item correlation module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to correlate consumer items and commercial vendors in a virtual model, e.g., an augmented reality display. In particular, the item correlation module 150 may capture an image of an item in a surrounding area. The item correlation module 150 may use the camera that is connected to a mobile device or is fixed in some way to recognize the surrounding area of the user at a specific time. The item may be identified in the image and a commercial vendor may be determined for the item by the item correlation module 150 by recognizing the surrounding area in the image as associated with the vendor or, alternatively, Internet of Things (IoT) data may be obtained to determine the location of the user and the determined location may be associated with the vendor. Fulfillment information, such as details about the item such as a model number or description and also specific information of the item relative to the vendor, e.g., a Stock Keeping Unit (SKU), warehouse status or shipping details, may be obtained and, together with the image, may be used to generate a “virtual storefront” for the vendor, e.g., a customized augmented reality display, that may have the fulfillment information from the commercial vendor overlaid on the image. Such a “storefront” may be viewed with an augmented reality (AR) device that may be worn by the user or in a browser on a mobile device using Web-Based Augmented Reality (WebAR) or other technology, and the image and fulfillment information may be updated as the user may move within the surrounding area. It is not required that augmented reality be used, only that the item correlation module 150 recognize items in the image and provide information connected to both the consumer item and the commercial vendor that is associated with the surrounding area of the image. At this point, if the user is interested in the consumer item, a request may be submitted for the consumer item and the item correlation module 150 may transmit the request for the consumer item after including an indication of the commercial vendor thus preserving the connection, or correlation, between the consumer item and the commercial vendor throughout the process, which is described in more detail below.

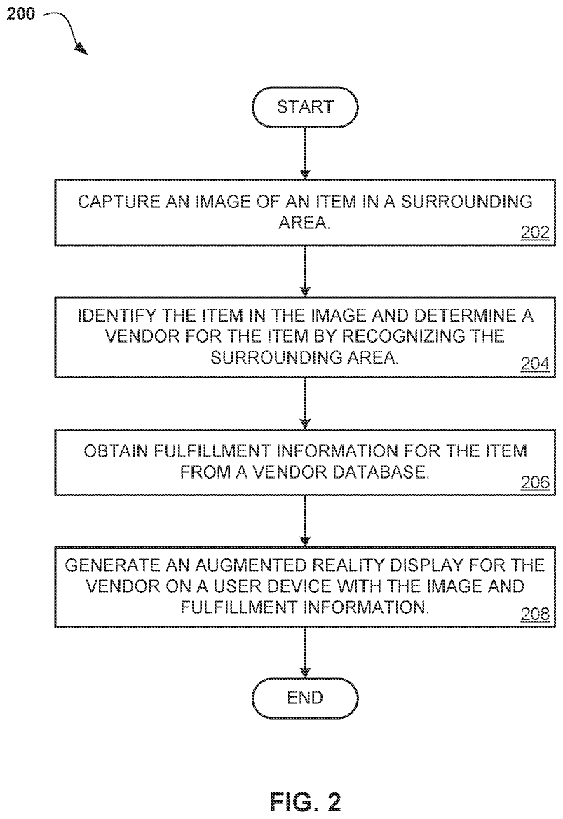

Referring to FIG. 2, an operational flowchart illustrating a process 200 that correlates consumer items and commercial vendors using a virtual model is depicted according to at least one embodiment. At 202, an image of a consumer item in a surrounding area may be captured using an appropriate device, which may be the camera of a smart phone or other mobile device carried by a user or may alternatively be fixed in the surrounding area. As described herein, the surrounding area may be a retail store or another type of space where consumer items may be present, though it is not required that the image be taken in a retail location or a store. In addition to the image, location data may also be obtained at the moment of image capture. The location data may be related to camera itself, or a mobile device using the camera in that case. In addition, Internet of Things (IoT) devices in the immediate surrounding area may also provide the location data. One of ordinary skill in the art will recognize that the obtained data may take many forms and it is only required that the process is informed of the location of the item such that a vendor may be identified for the item based on the location data.

It should be noted that all collection of information that may personally identify any user or is sensitive in any other way requires the informed consent of all people whose information may be collected and analyzed for the purposes of the invention. Consent may be obtained in real time or through a prior waiver or other process that informs a subject that their information may be captured by a device or other process and that the information may be used in recognizing a surrounding area or identifying a vendor associated with the surrounding area, as will be described below. The information owner is free to decide at any time to revoke consent for use of sensitive information as these settings are permanently retained to keep the item allocation module 150 updated with the latest information and also allow the owner of the information complete control over their informed consent to use sensitive information in the course of the invention. The consent described here may also refer to allowing some, or any, data relating to an information owner's vehicle from being sent to a local server, cloud server or any other location. The owner has complete control on the transmission of information that may be sensitive or personally identify the owner of the information.

At 204, the item may be identified by the item allocation module 150 and a vendor for the item may be determined based on recognizing the surrounding area in the image. Various computer vision techniques may be employed to recognize both the item and any objects or text or other specific characteristics of the surrounding area that may be present in the image. In an embodiment, a commercial vendor may take multiple images of items in a retail space that the vendor may own and operate, as well as the surrounding area where the items may be mounted or displayed. The vendor may catalog the items and label the images with metadata or other fulfillment information, such that a virtual model or augmented reality display may be created specifically for the vendor as will be described below.

In addition to images, location data may also be obtained for the image, as well as prior transaction data that may be present for the item and the vendor. For instance, if a user is in a retail outlet and the image is captured using a camera on a mobile device associated with the user, location data may be obtained from the mobile device or other Internet of Things (IoT) devices in the immediate vicinity, such that the location of the user and/or the image may be identified. By matching the location data to a known location of the vendor, the vendor for the item may be associated with the surrounding area. For instance, if the user is in a retail store and the location data that may be obtained is associated in a mapping database as belonging to the vendor for the item, this match of the location data and the location of the vendor would allow the vendor for the item and the surrounding area to be associated with each other. In the event that the surrounding area has not been associated with a vendor or specific items are not detected or recognized, then a prompt may be displayed on the screen of a device to allow for manual entry of the item or vendor into the item allocation module 150 for later detection or association with a commercial vendor using any location data that may also be obtained.

In an embodiment, a supervised machine learning model may be trained to predict the vendor associated with the surrounding area based on the item in the image and location data. One or more of the following machine learning algorithms may be used: logistic regression, naive Bayes, support vector machines, deep neural networks, random forest, decision tree, gradient-boosted tree, multilayer perceptron. One of ordinary skill in the art will recognize that this is a non-limiting list of algorithms that may be used at this step. In an embodiment, an ensemble machine learning technique may be employed that uses multiple machine learning algorithms together to assure better classification when compared with the classification of a single machine learning algorithm. In this embodiment, training data for the model may comprise prior transaction data or information about consumer items that may be manually or automatically correlated with a vendor. The training data may be collected from a single transaction or consumer item or from multiple consumer items or transactions over a longer period of time. The results may be stored in a database so that the data is most current, and the output would always be up to date.

At 206, fulfillment information about each item that may be recognized in the image may be obtained from a vendor database. This fulfillment information may include simple metadata such as a title, author or publisher of a book or a product model number or manufacturer of a product but may also include product information that is specific to the vendor associated with the surrounding area, such as a SKU number or other details. The fulfillment information may also include pricing information, shipping information, or other fulfillment options as appropriate. For instance, if a detected item is a display model and the item needs to be ordered, then this information may be included in the obtained fulfillment information. This list of possible information is not meant to be exhaustive, but rather to illustrate the information that may be obtained from the vendor database, which one of ordinary skill in the art will recognize may take several forms. The vendor database may be created and stored locally or on a network by a vendor, such that the vendor's inventory may exist in the database as an item that is associated with the vendor and the fulfillment information may be manually or automatically entered into the vendor database. In addition, once a virtual model or augmented reality display is created for the vendor, this display may exist as a digital file that may also be associated with the commercial vendor and stored in the vendor database, either as a full display, or “virtual storefront,” that notes individual locations of items in the display, or a digital representation of each item that may later be assembled into a full virtual model or display. In an embodiment, the item allocation module 150 may reference a more general vendor database that may have entries from multiple vendors and select from the more general database in the process of determining the vendor for the item that is described above.

At 208, a virtual model such as an augmented reality display may be generated for the vendor that includes both the image and the fulfillment information about the item that may be recognized in the image described above. The virtual model may be generated using Web-Based Augmented Reality (WebAR) and a browser such that the image that may be captured may be displayed with the fulfillment information for each item overlaid on the respective item to provide the information in the most efficient manner possible. However, overlaying the fulfillment information is not required, only that a display include the information along with the image. In addition, the image need not be static but rather, additional images may be captured, and the virtual model may be continuously updated to reflect movements of a user as appropriate. At some point, a user may make a request to purchase the item, perhaps from the commercial vendor but also possible from an online retailer that may not be related to the vendor. The process may respond to the user submitting a request for the item by adding an indication of the vendor for the item to the request and then may transmit the modified request to the server. The indication may include the fulfillment information that may be part of the virtual model and is intended to correlate the request and the item with the commercial vendor. In the course of displaying the virtual model to a user, the item allocation module 150 may also obtain a profile for the user, e.g., account information or other details that may be available about a user's relationship with the vendor, and modify the fulfillment information accordingly, such that the overlaid information may reflect the user-specific information and, should a request for the item be made by the user, the request for the item may also be modified accordingly.

The item allocation module 150 may further continuously monitor interactions of users and vendors with the virtual model and also any requests or transactions that may involve the consumer item. If the item is recognized incorrectly, this may be noted by the user or vendor in order to update the algorithm that may be performing the object recognition. At the same time, the recognition of the surrounding area may also be updated by feedback from the user or vendor, as well as the association between the surrounding area and the vendor. For instance, if the location data is obtained and the information for that location is incorrect, then the association may be updated to reflect any new information, whether automatically obtained or through manual feedback from a user or vendor.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for correlating consumer items and commercial vendors, the computer-implemented method comprising:
capturing an image of an item and a surrounding area;
identifying the item in the image and determining a vendor for the item by recognizing the surrounding area in the image and associating the surrounding area with the vendor for the item;
obtaining fulfillment information for the item from a vendor database; and
generating a virtual model for the vendor for the item, wherein the virtual model includes the image and the fulfillment information for the item.

2. The computer-implemented method of claim 1, further comprising:
receiving a request for the item from a user based on the virtual model for the vendor for the item;
modifying the request for the item by adding an indication of the vendor; and
transmitting a modified request for the item to a server.

3. The computer-implemented method of claim 1, further comprising:
obtaining location data for the surrounding area from a device; and
associating the surrounding area with the vendor for the item when the location data matches a vendor location.

4. The computer-implemented method of claim 3, wherein a machine learning model that predicts the vendor based on prior transactions and the location data is used to determine the vendor for the item.

5. The computer-implemented method of claim 2, further comprising:
displaying the request for the item to the vendor for the item;
monitoring interactions of the vendor for the item with the request for the item; and
updating the request for the item based on the interactions.

6. The computer-implemented method of claim 1, further comprising storing the virtual model for the vendor for the item in the vendor database.

7. The computer-implemented method of claim 2, further comprising obtaining a profile of the user and modifying the fulfillment information for the item based on the profile of the user.

8. A computer system for correlating consumer items and commercial vendors, the computer system comprising:
one or more processors, one or more computer-readable memories, and one or more computer-readable storage media;
program instructions, stored on at least one of the one or more computer-readable storage media for execution by at least one of the one or more processors via at least one of the one or more computer-readable memories, to capture an image of an item and a surrounding area;
program instructions, stored on at least one of the one or more computer-readable storage media for execution by at least one of the one or more processors via at least one of the one or more computer-readable memories, to identify the item in the image and determine a vendor for the item by recognizing the surrounding area in the image and associating the surrounding area with the vendor for the item;
program instructions, stored on at least one of the one or more computer-readable storage media for execution by at least one of the one or more processors via at least one of the one or more computer-readable memories, to obtain fulfillment information for the item from a vendor database; and
program instructions, stored on at least one of the one or more computer-readable storage media for execution by at least one of the one or more processors via at least one of the one or more computer-readable memories, to generate a virtual model for the vendor for the item, wherein the virtual model includes the image and the fulfillment information for the item.

9. The computer system of claim 8, further comprising:
program instructions, stored on at least one of the one or more computer-readable storage media for execution by at least one of the one or more processors via at least one of the one or more computer-readable memories, to receive a request for the item from a user based on the virtual model for the vendor for the item;
program instructions, stored on at least one of the one or more computer-readable storage media for execution by at least one of the one or more processors via at least one of the one or more computer-readable memories, to modify the request for the item by adding an indication of the vendor; and
program instructions, stored on at least one of the one or more computer-readable storage media for execution by at least one of the one or more processors via at least one of the one or more computer-readable memories, to transmit a modified request for the item to a server.

10. The computer system of claim 8, further comprising:
program instructions, stored on at least one of the one or more computer-readable storage media for execution by at least one of the one or more processors via at least one of the one or more computer-readable memories, to obtain location data for the surrounding area from a device; and
program instructions, stored on at least one of the one or more computer-readable storage media for execution by at least one of the one or more processors via at least one of the one or more computer-readable memories, to associate the surrounding area with the vendor for the item when the location data matches a vendor location.

11. The computer system of claim 10, wherein a machine learning model that predicts the vendor based on prior transactions and the location data is used to determine the vendor for the item.

12. The computer system of claim 9, further comprising:
program instructions, stored on at least one of the one or more computer-readable storage media for execution by at least one of the one or more processors via at least one of the one or more computer-readable memories, to display the request for the item to the vendor for the item;
program instructions, stored on at least one of the one or more computer-readable storage media for execution by at least one of the one or more processors via at least one of the one or more computer-readable memories, to monitor interactions of the vendor for the item with the request for the item; and
program instructions, stored on at least one of the one or more computer-readable storage media for execution by at least one of the one or more processors via at least one of the one or more computer-readable memories, to update the request for the item based on the interactions.

13. The computer system of claim 8, further comprising program instructions, stored on at least one of the one or more computer-readable storage media for execution by at least one of the one or more processors via at least one of the one or more computer-readable memories, to store the virtual model for the vendor for the item in the vendor database.

14. The computer system of claim 9, further comprising program instructions, stored on at least one of the one or more computer-readable storage media for execution by at least one of the one or more processors via at least one of the one or more computer-readable memories, to obtain a profile of the user and modify the fulfillment information for the item based on the profile of the user.

15. A computer program product for correlating consumer items and commercial vendors, the computer program product comprising:
one or more computer-readable storage media;
program instructions, stored on at least one of the one or more computer-readable storage media, to capture an image of an item and a surrounding area;
program instructions, stored on at least one of the one or more computer-readable storage media, to identify the item in the image and determine a vendor for the item by recognizing the surrounding area in the image and associating the surrounding area with the vendor for the item;
program instructions, stored on at least one of the one or more computer-readable storage media, to obtain fulfillment information for the item from a vendor database; and
program instructions, stored on at least one of the one or more computer-readable storage media, to generate a virtual model for the vendor for the item, wherein the virtual model includes the image and the fulfillment information for the item.

16. The computer program product of claim 15, further comprising:
program instructions, stored on at least one of the one or more computer-readable storage media, to receive a request for the item from a user based on the virtual model for the vendor for the item;
program instructions, stored on at least one of the one or more computer-readable storage media, to modify the request for the item by adding an indication of the vendor; and
program instructions, stored on at least one of the one or more computer-readable storage media, to transmit a modified request for the item to a server.

17. The computer program product of claim 15, further comprising:
program instructions, stored on at least one of the one or more computer-readable storage media, to obtain location data for the surrounding area from a device; and
program instructions, stored on at least one of the one or more computer-readable storage media, to associate the surrounding area with the vendor for the item when the location data matches a vendor location.

18. The computer program product of claim 17, wherein a machine learning model that predicts the vendor based on prior transactions and the location data is used to determine the vendor for the item.

19. The computer program product of claim 16, further comprising:
program instructions, stored on at least one of the one or more computer-readable storage media, to display the request for the item to the vendor for the item;
program instructions, stored on at least one of the one or more computer-readable storage media, to monitor interactions of the vendor for the item with the request for the item; and
program instructions, stored on at least one of the one or more computer-readable storage media, to update the request for the item based on the interactions.

20. The computer program product of claim 15, further comprising program instructions, stored on at least one of the one or more computer-readable storage media, to store the virtual model for the vendor for the item in the vendor database.
